(19) United States
(12) Patent Application Publication
(10) Pub. No.: US 2004/0060772 A1
(43) Pub. Date: Apr. 1, 2004

(54) Rescue system for high-rise buildings

(76) Inventor: Eliyahu Nir, Netania (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 10/214,122

(22) Filed: Aug. 8, 2002

(51) Int. Cl. A62B 1/20

(52) U.S. Cl. 182/48

(57) ABSTRACT

A system for the evacuation of individuals trapped in multiple story buildings by gliding down a rescue sleeve. The sleeve (12) is composed of sections (20), each section being made of a sheet material strengthened by a circumferential rigid support member (22), the sections are connected to each other to form a continuous envelope. At least a pair of cables (26; 27) are provided, thread along the sleeve, one (26) at the bottom and one (27) at the top generatrix thereof. A pair of winch systems (52; 54) are provided for winding the cables (26; 27) into a dedicated location (50) at the building story from which rescue is requested, so that the sleeve (12) becomes folded into a compact package. Coil springs (60; 62) are used for selectively ejecting and unfolding the sleeve down to ground level where it becomes tied to stationary objects (16; 17).

### FIELD OF THE INVENTION

The present invention relates to rescue systems for evacuating individuals trapped in high-rise buildings in case of an emergency situation, typically fire.

More specifically the invention concerns fire escapes using chutes or tubes through which individuals glide down from the building.

### BACKGROUND OF THE INVENTION

The first known attempts to tackle the problem at hand are disclosed in and by U.S. Pat. Nos. 908,034 (Dec. 29, 1908) and 1,520,440 (Dec. 23, 1924), both to Frank Pyleck and entitled “Automatic Fire-Escape”.

In the first Patent there was described a foldable chute normally stored in a box that is hingedly supported. In the standby position, the box is arrested against the outer wall of the building, at one side of a window. When needed, the box is released and allowed, under the bias of springs, to smash into and is break open the window. The chute becomes released and projects down. The ejection of the chute, as well as its support in a sloping down to ground level position, are sustained by a coil spring wound around the chute along its entire length, while the exit side is freely rested on the ground.

Further disclosed were a pair of cords passed along the chute by which the chute can be collapsed and folded back into the storage box.

In the second, later Patent, the inventor proposed to substitute the supporting coil spring by a solid track or rail permanently mounted to the building wall above the window and inclining down parallel to the path of the unfolded chute. The chute, after being deployed will be suspended from the rail by a series of wheeled hangers running along the rail.

Quite obviously, these solutions might have been of some merit at the beginning of the past century with regard to buildings of, say, four or five stories at the most, but out of the question for modern hi-rise buildings. Hence, and only quite recently, other solutions have been proposed—cf. U.S. Pat. Nos. 4,099,596 (1978); 4,240,520 (1980); 4,398,621 (1983), and 4,580,659 (1986), each one pointing in a different direction and none of them known to have gained commercially successful implementation.

It is therefore the general object of the present invention to overcome the deficiencies of the prior art chute-gliding fire-escape systems.

It is a further object of the invention to employ a tension cable as the only supporting means of the sliding sleeve.

It is a still further object of the invention to provide delimiting stretches of cables, associated with the same tension cable for forming knee-like sections along the sleeve for locally moderating the inclination angle thereof.

### SUMMARY OF THE INVENTION

Thus provided according to the present invention is a system for the evacuation of individuals trapped in multiple story buildings by gliding down a tubular rescue sleeve, stored in a compact package form located at an elevated story of the building. The system comprises a sleeve composed of sections, each section being made of a sheet material strengthened by a circumferential rigid support member. A first tension cable is stretched along the sleeve, following the top generatrix thereof, being freely passed through respective eyelet means mounted to the support members. Means are provided for selectively ejecting and unfolding the sleeve along the first tension cable down to ground level, and for tying the first tension cable to a remotely located stationary object.

Further novel features and other objects of this invention will become apparent from the following detailed description, discussion, and the appended claims taken in conjunction with the accompanying drawings.

### BRIEF DESCRIPTION OF THE DRAWINGS

FIG. 1 is a schematic perspective view of the emergency rescue system in the operative position thereof;

FIG. 2 is an enlarged view of the down-stream end of the rescue sleeve;

FIG. 2a is a side view, showing the end side of the sleeve;

FIGS. 3a-3d are details of construction relating to the rings interposed between successive sections of the sleeve;

FIG. 4a illustrates the connection between adjacent sleeve sections;

FIG. 4b is a partial side view of FIG. 4a;

FIG. 5 shows a knee-forming arrangement;

FIG. 6 is a detail of construction relating to the attachment of auxiliary cables;

FIG. 7 is a partly sectional side view of the sleeve-storing compartment, taken along line VII-VII of FIG. 8;

FIG. 8 is a view taken along line VIII-VIII of FIG. 7;

FIG. 9 is a view taken along line IX-IX of FIG. 7;

FIG. 9a is a detail of construction relating to FIG. 9;

FIG. 10 is a view taken along line X-X of FIG. 7;

FIG. 11 is a view taken along line XI-XI of FIG. 7;

FIG. 12 is a view taken along line XII-XII of FIG. 8;

FIG. 13 is a sectional view similar to that of FIG. 7, following the ejection of the sleeve from the standby position; and

FIG. 14 shows the system in the sleeve deployed position prior to the anchoring as depicted in FIG. 1.

### DETAILED DESCRIPTION OF THE PREFERRED EMBODIMENTS

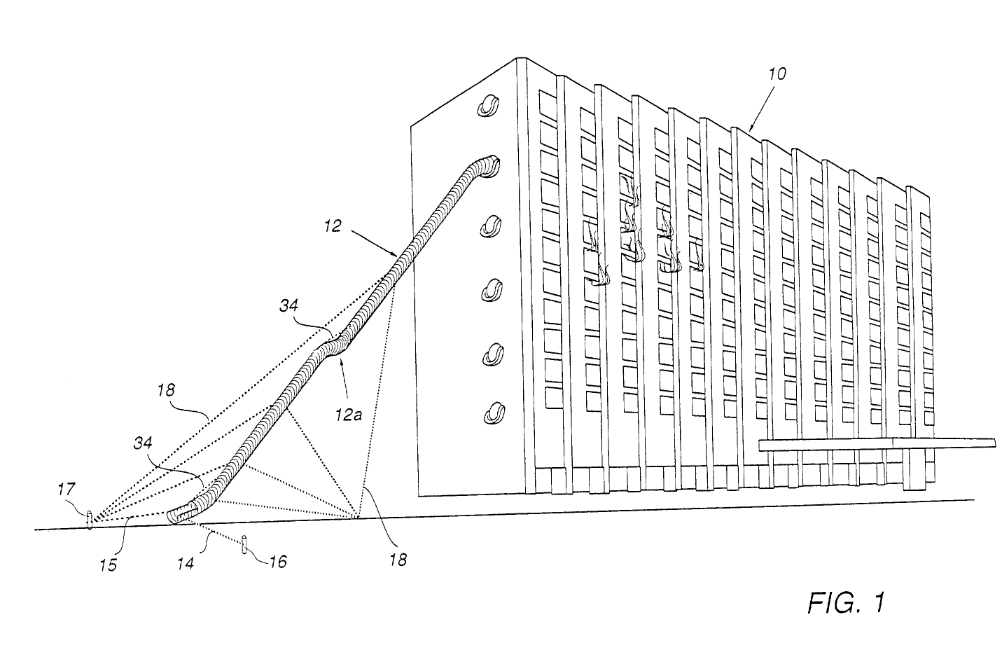

In FIG. 1 there is illustrated a multiple story building 10 (residential or hotel) where a fire has started.

Rescue sleeve or chute 12 has been ejected as will be described in greater detail below. The exit side of the sleeve 12 is brought (e.g. by a specially trained rescue team) to a convenient evacuation point, namely that is as far from the building as allowed by the length the sleeve on the one hand and by the surrounding topography (nearby buildings or other obstacles) on the other hand. As already mentioned, the sleeve is self-supported by anchoring the exit side of the sleeve, e.g. by cables 14 and 15 connected to at least tension cable 27 (see below) to any kind of stable objects such as nearby parked vehicles, trees, street lamp posts and the like, schematically represented by poles 16 and 17. Preferably though, for the sake of better support and greater safety, a number of auxiliary anchor cables 18 should be available and used as shown and will be described further below.

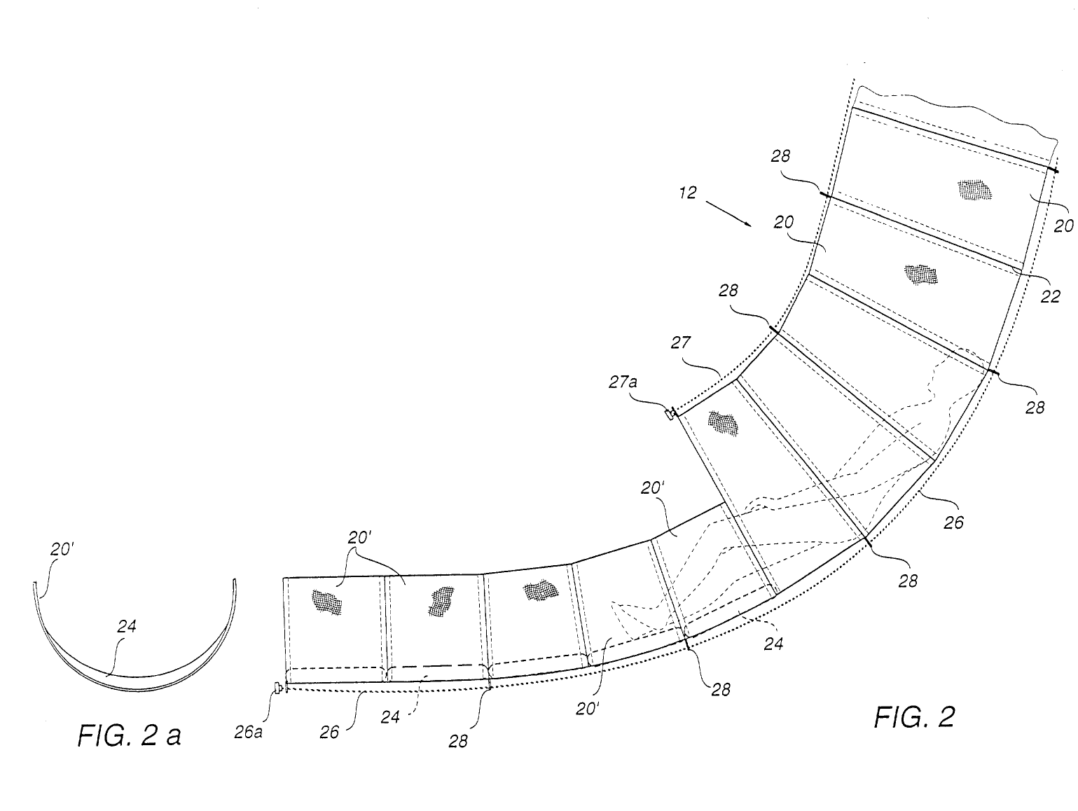

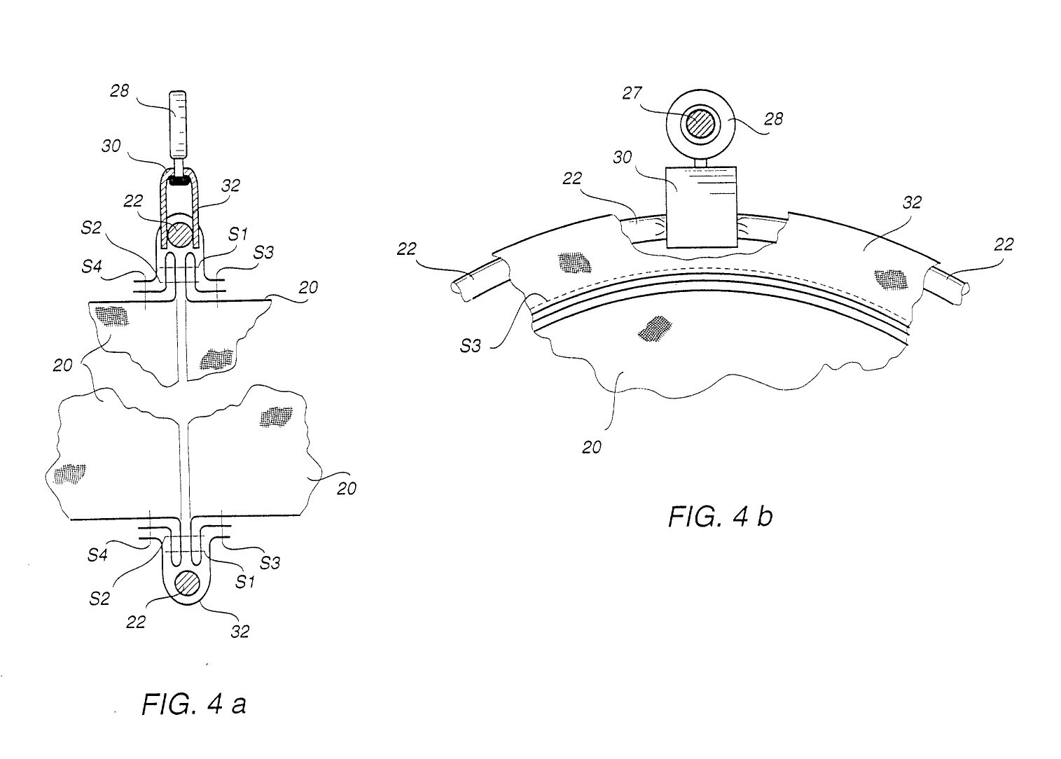

It will be further noted (see FIG. 2) that the sleeve 12 is mostly made of tapeworm-like structure, namely a chain of sections 20, which are made of strong sheet material such as nylon, canvas fabric and the like, sewn to each other and strengthened by rigid rings generally denoted 22 (see FIG. 4).

At the lowermost portion, however, the structure of the sleeve 12 can be half-open (sections 20′), and provided with preferably self-inflated cushions 24, intended to brake and absorb the gliding movement of the rescued persons (shown in phantom lines) using the sleeve.

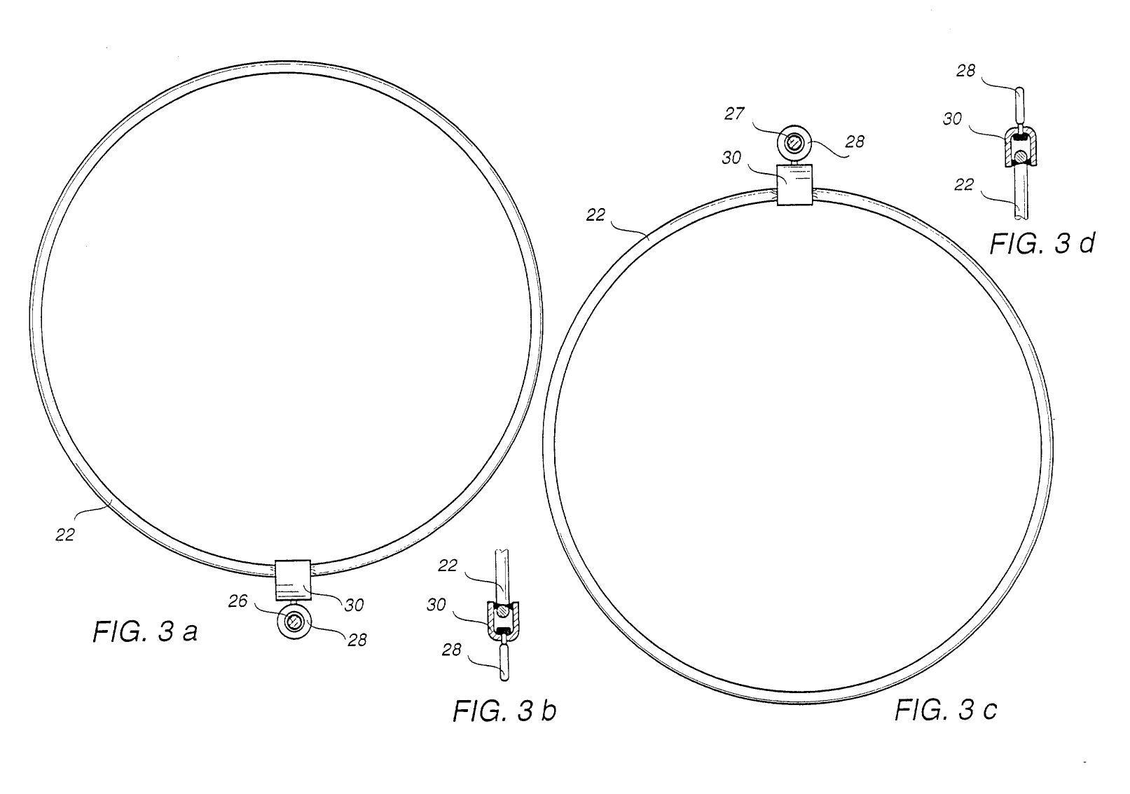

In addition there are provided a pair of tension cables 26, 27, running all along the sleeve 12. Cable 26 runs at the bottom side, threaded through eyelets 28 mounted to every second one of the rings 22. Every eyelet is preferably pivotally connected (FIGS. 3a-3d) via a U-shaped bracket 30 which is welded to the respective ring 22.

A plug 26a is affixed to the end of the cable 26.

The same arrangement exists with respect to the top running cable 27, which is threaded through eyelets 28 in a staggered fashion relative to cable 26.

Yet another detail of construction is shown in FIGS. 4a and 4b. This relates to the manner the sleeve sections 20 are sewn to each other and to the rings 22. Hence, the margins of each section are bent radially outwards, folded about themselves and fastened by stitches S1 and S2, leaving an extended portion directed backwards. The ring 22 is then assembled by a circular wrapping 32 of cloth which envelops the ring and is fastened to the said extended portions by stitches S3 and S4.

The brackets 30 for the eyelets 28 will of course penetrate outwards of the envelope 32 (FIG. 4b).

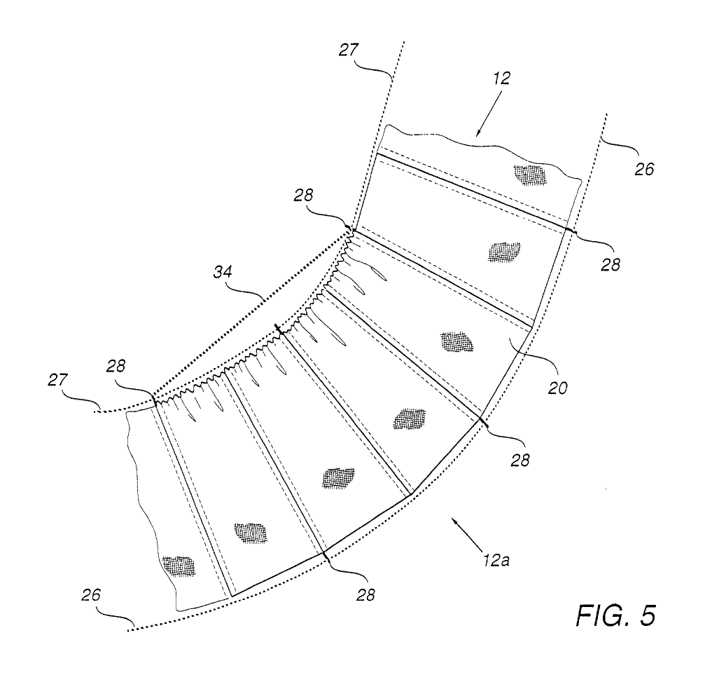

The arrangement of FIG. 5 may be adopted in order to form locally knee-like sections that will serve to moderate the speed of the free gliding persons by constituting successive stretches of less-steep angles. When in the folded state (see below), several stretches of an additional delimiting cable 34 are tied, at certain intervals between distanced eyelets of the top cable 27, restricting the distance between the respective rings at their upper points to a pre-set length. This will cause the sleeve 12 to form knee-like sections 12a when unfolded. The number of such knee-like sections 12a will be determined according to the overall height of the sleeve (i.e. the respective building story) and the amount of the final desired curvature of the sleeve as a whole.

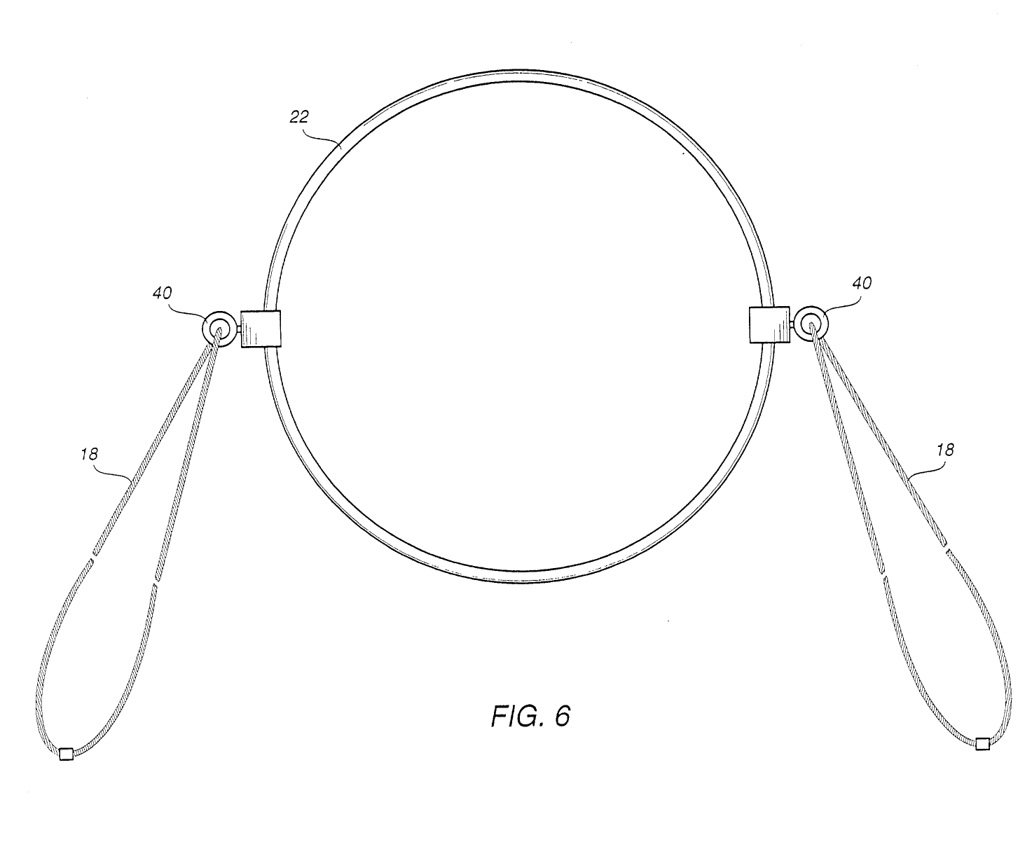

As already mentioned, auxiliary anchor cables 18 (FIG. 1) may be requested. For that purpose, a second series of swivable eyelets 40 are employed (FIG. 6), diametrically located in a horizontal plane, deployed along the sleeve and mounted to several, distanced rings 22.

As further seen in FIG. 6, the eyelet configuration is advantageous, allowing the auxiliary anchor cables 18 be constituted by loops, the idea being that after use, the cables can be cut and completely removed from the sleeve. This is important for facilitating a smooth folding back of the sleeve for re-use (see below), without needing to attend specially to the orderly collection of these cables.

The re-installment of the cables 18 will take place at a later stage, in the folded-back state of the sleeve, through a service opening (sliding doors 74 and 75), as will be described later on.

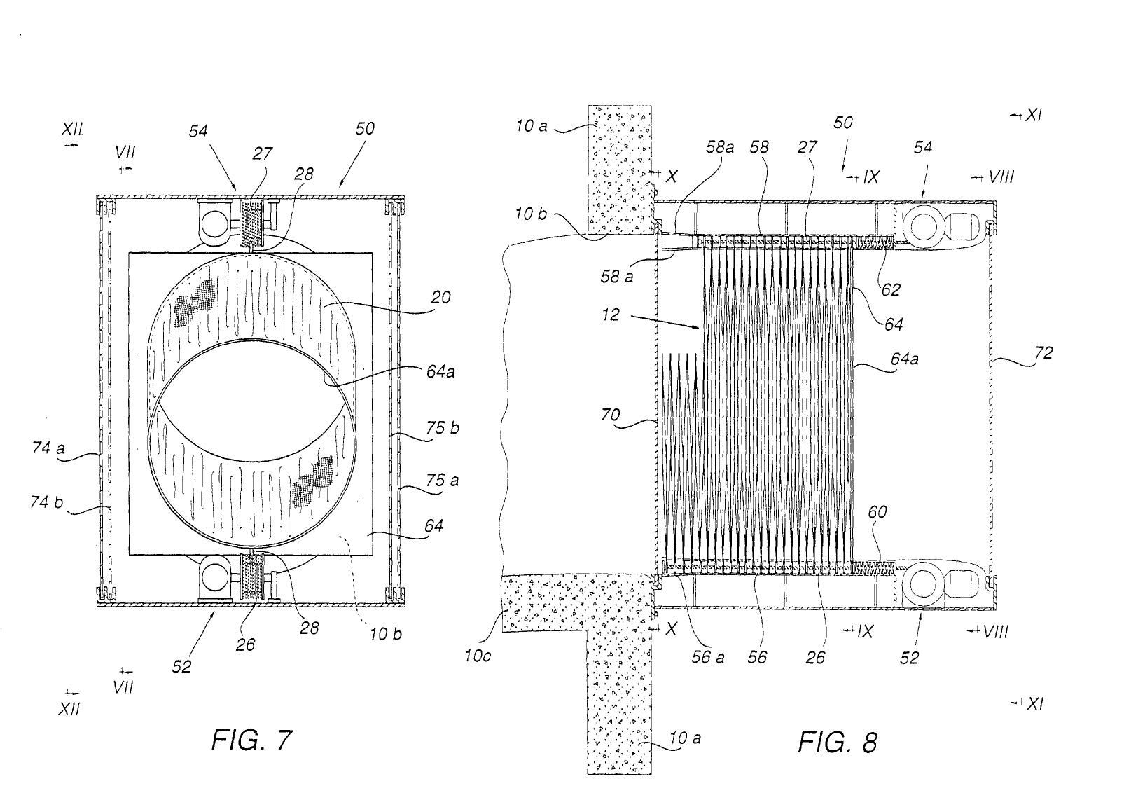

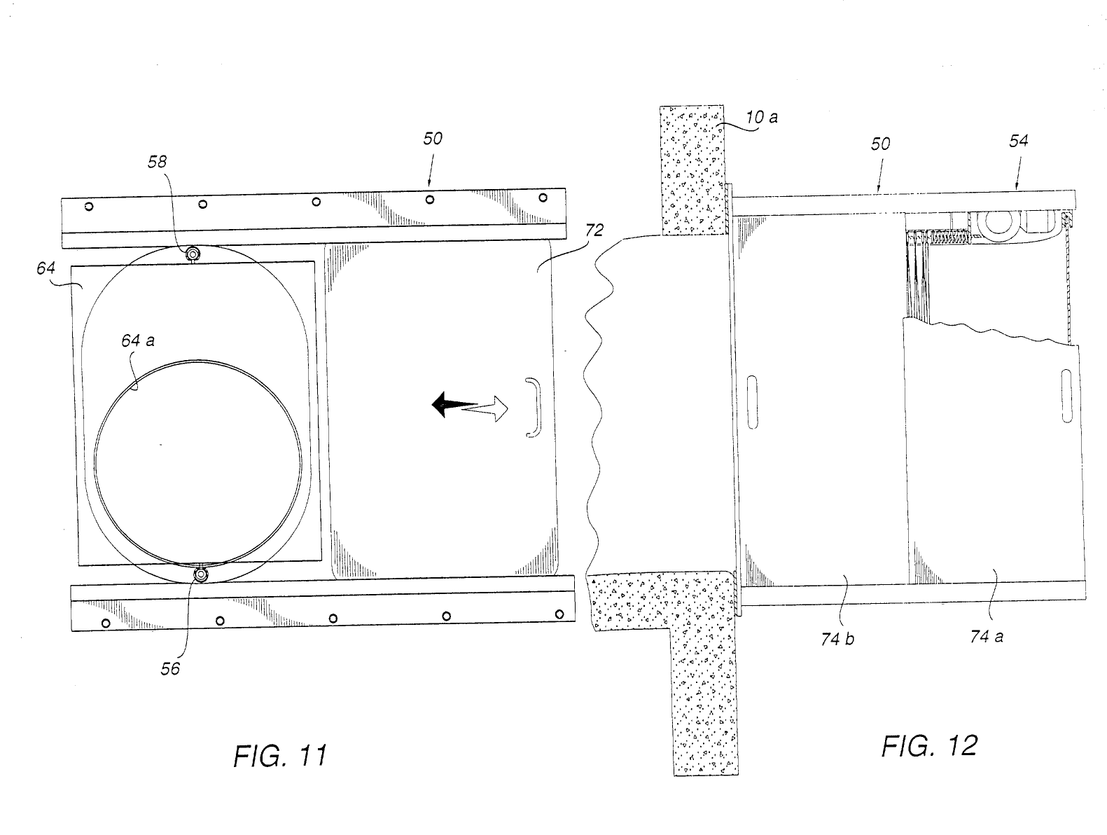

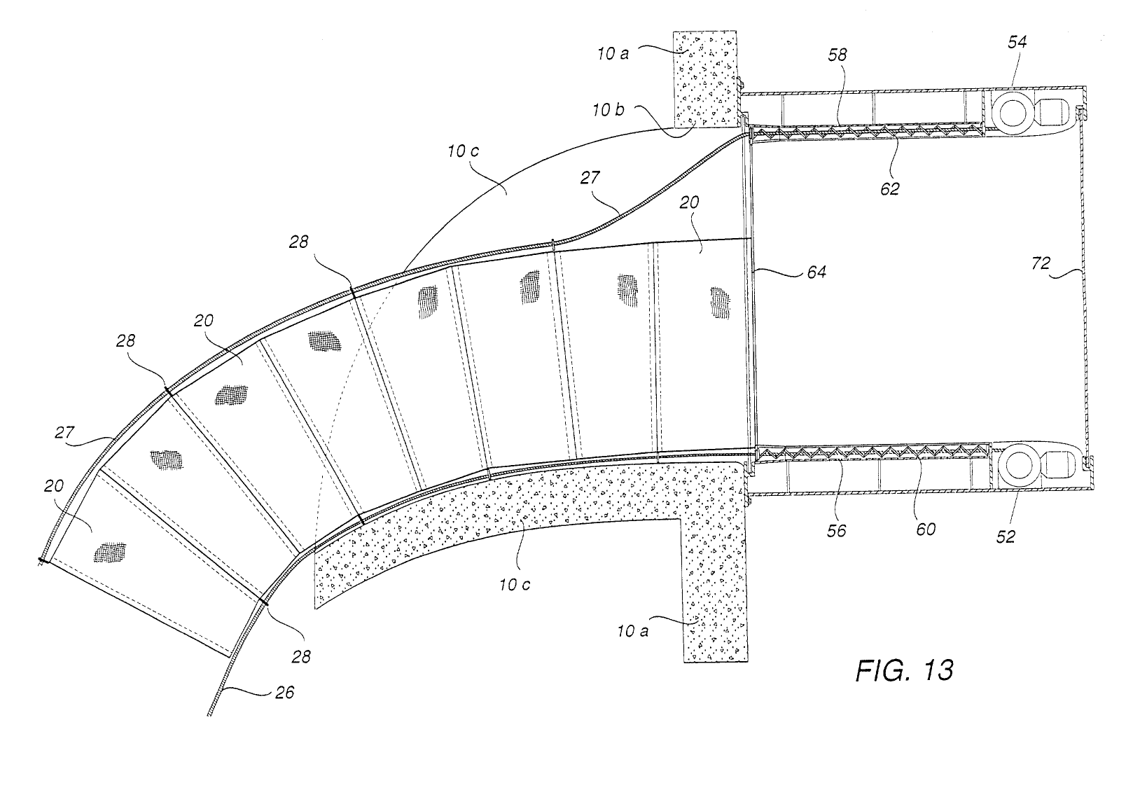

Reference shall now be made to FIGS. 7-12. At every story of the building 10, next to an external wall 10a, a compartment generally denoted 50 will be installed, associated with a dedicated preferably oval opening 10b with a funnel-like extension 10c (FIG. 13).

The rescue sleeve 12 is shown in the folded, stand-by state, after the cables 26 and 27 have been fully rewound by respective electrically powered winch systems 52 and 54.

Cable 26 passes through a guiding tube 56, having for that purpose a somewhat flared opening portion 56a. The same applies with respect to tube 58 for cable 27.

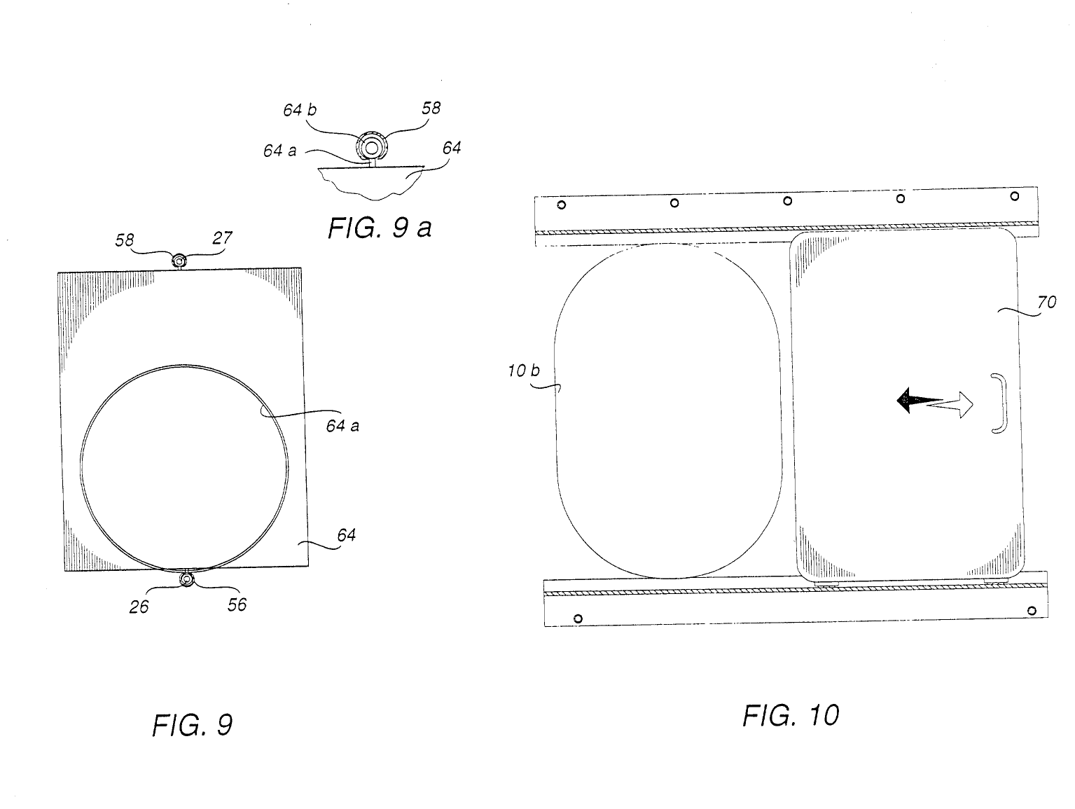

Coil springs 60 and 62 are installed, both acting against a common backup plate 64 (see FIG. 9) defining the surface against which the sleeve 12 is folded, in an accordion-like fashion.

The backup plate 64 has an entering opening 64a, equal to or larger than the diameter of the sleeve 12.

Since the distance between the tubes 56 and 58 is greater than the diameter of sleeve 12, and in view of the alternate order of the eyelet 28 relative to the lower cable 26 and the upper cable 27, the sleeve sections 20 will become folded not overlapping each other, but in a staggered, zig-zag fashion, to save storing space.

The compartment 50 is made of metal construction, and is provided with a first, weather-proof sliding door 70 (see FIG. 10), a second sliding door 72, facing the interior of the building, and two pairs of third service sliding door systems 74a, 74b and 75a, 75b (see FIGS. 8 and 12) at both sides of the compartment 50, serving to allow access from the side for re-connecting the auxiliary anchor cables 18 after the use of the rescue sleeve and the cable having been cut and removed to facilitate smooth and trouble-free folding-back of the sleeve into its stand-by position.

The operation of the rescue-sleeve system is illustrated in FIG. 13. Hence, in case of emergency, the door 70 is pulled aside (see FIG. 10) and the winch systems 52 and 54 released for free wheel rotation of their drums. Consequently, under the force of the springs 60 and 62, the plate 64 will shoot (to the left in FIG. 7) and cause the folded sleeve to become ejected out through the opening 10b and paid down over the funnel shaped section 10c provided for that purpose.

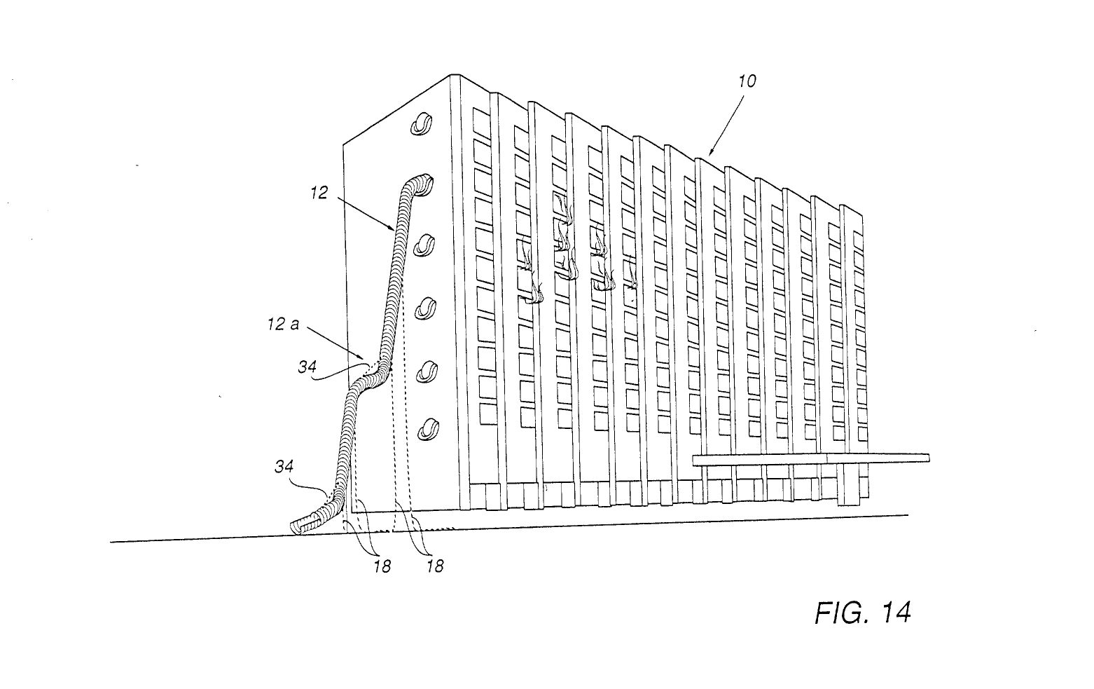

Now, the position of FIG. 14 is reached, where the sleeve 12 freely hangs down, except for the knee section(s) 34 that start shaping the sleeve towards the operative position of FIG. 1.

The auxiliary cables 18 (having been attached and prepared in the folded position of the sleeve as already explained) hang freely down as shown, ready to be picked up by the rescue team and tied to any available stationary object. The free end of the sleeve is tied by at-least the tension cable 27 as already explained with reference to FIG. 1 and the system is ready for its life saving goal.

While the above description contains many specificities, these should not be construed as limitations on the scope of the invention, but rather as exemplification of the preferred embodiments. Those skilled in the art will envision other possible variations that are within its scope. Accordingly, the scope of the invention should be determined not by the embodiment illustrated, but by the appended claims.

What is claimed is:

1. A system for the evacuation of individuals trapped in multiple story buildings by gliding down a tubular rescue sleeve, stored in a compact package form located at an elevated story of the building, comprising:
a sleeve composed of sections, each section being made of a sheet material strengthened by a circumferential rigid support member;
a first tension cable stretched along the sleeve, following the top generatrix thereof, being freely passed through respective eyelet means mounted to the support members;
means for selectively ejecting and unfolding the sleeve along the first tension cable down to ground level; and
means for tying the first tension cable to a remotely located stationary object.

2. The system as claimed in claim 1 further comprising a second tension cable stretched along the sleeve following the bottom generatrix thereof, being freely passed through respective eyelet means mounted to the support members.

3. The system as claimed in claim 2 wherein the first and the second cables are threaded through every second eyelet, respectively, in a staggered order.

4. The system as claimed in claim 3 further comprising a winch system for winding the first and second cables into a dedicated location at the said elevated building story so that the sleeve becomes folded into the said compact package form.

5. The system as claimed in claim 4 wherein the first and second cables are each wound through a guide tube, the vertical distance between the guide tubes exceeds the distance between the top and the bottom eyelets, so that the sleeve becomes folded in a zig-zag, space-saving order.

6. The system as claimed in claim 5 wherein coil springs are located in each guide tube around their respective cable.

7. The system as claimed in claim 6 wherein a pair of winch systems are provided, each comprising a drum around which the cables are wound.

8. The system as claimed in claim 7 wherein the winch systems comprise means for releasing their drums to enable the said ejecting and unfolding of the sleeve.

9. The system as claimed in claim 8 wherein a backup plate is provided against which the sleeve becomes folded upon winding of the cables.

10. The system as claimed in claim 9 further comprising a slidable door adapted to close an opening in the building through which the sleeve is folded by the winch system(s).

11. The system as claimed in claim 2 wherein the eyelets are swivably mounted to their respective rigid support members.

12. The system as claimed in claim 1 further comprising means for forming at least one knee-like section of the sleeve in the unfolded state thereof.

13. The system as claimed in claim 12 wherein the knee-like section forming means comprise a stretch of cable tied between selected eyelets located at the top of the sleeve, the length of the cable being less than the distance between the eyelets when the sleeve is unfolded.

14. The system as claimed in claim 1 further comprising auxiliary cables adapted to be anchored to stationary objects at ground level for stabilizing the sleeve in its unfolded state.

15. The system as claimed in claim 14 wherein the auxiliary cables are connected to selected ones of the rigid support members, at two diametrically opposite sides thereof in a horizontal plane.

16. The system as claimed in claim 15 wherein the auxiliary cables are constituted by loops passed through respective rings mounted to the rigid support member(s).
